(19) United States
(12) Patent Application Publication
(10) Pub. No.: US 2009/0148567 A1
(43) Pub. Date: Jun. 11, 2009

(54) Food Product System and Associated Methods

(76) Inventor: Robert Phillips, Foothill Ranch, CA (US)

Correspondence Address: MARK R. MALEK, ESQUIRE;THE TORPY GROUP, P.L., SUITE 200, 202 N. HARBOR CITY BLVD., MELBOURNE, FL, 32935, US

(21) Appl. No.: 11/952,180

(22) Filed: Dec. 7, 2007

(51) Int. Cl. A21D 13/00; A23L 1/00

(52) U.S. Cl. 426/76; 426/134; 426/390; 426/549

(57) ABSTRACT

A food product system preferably includes an edible handheld container and an edible core product adapted to be detachably connected to a skewer and selectively carried by the container. The core product may be detached from the skewer and selectively carried by the container as the skewer is moved from an engaged position with the container to a disengaged position with the container.

### FIELD OF THE INVENTION

The present invention relates to the field of foods and, more specifically, to the field of foods that may be assembled and consumed.

### BACKGROUND OF THE INVENTION

Food products that require assembly before consumption are generally known. Some examples are sandwiches and other appetizers, e.g., cheese and crackers. Desserts that require assembly are also well known. For example, ice cream can be an assembled dessert that requires positioning ice cream inside of an ice cream cone. Of course, it is imperative that the ice cream cone have a solid bottom so that as ice cream melts within the cone, it does not seep through the bottom and onto the user.

Ice cream cones have evolved over the years to enhance desserts. As illustrated, for example, in U.S. Design Pat. No. 56,488 to Winder, the earliest of ice cream cones were simply a conically shaped container to hold ice cream. As illustrated in U.S. Design Pat. No. 153,352 to Halset, the ice cream cone eventually evolved into the ice cream cup. Eventually, an apparatus for molding ice cream cups out of baking batter was introduced as disclosed, for example, in U.S. Pat. No. 2,749,853 to Graham. Other ingredients have been used to enhance the flavor of ice cream cones. For example, baked cookie dough is used to form the edible containers disclosed in U.S. Pat. No. 5,223,286 to Selbak. U.S. Pat. No. 6,235,324 to Luigi Grigoli et al. discloses a composite ice cream cone having a filling contained within a pair of wafer shells. U.S. Design Pat. No. 501,977 to Carbone discloses an ice cream cone that departs from the traditional conical shape but that appears to have a coating affixed to the sidewalls thereof.

Another type of dessert that requires assembly is a s'more. Campers routinely enjoy making and consuming s'mores. S'mores are generally known to be a toasted marshmallow and a piece of chocolate sandwiched between a pair of graham crackers.

Anyone who has ever made a s'more, however, will appreciate that they can be difficult to make, and messy to consume. The process of making a typical s'more includes placing a marshmallow on an elongate skewer and toasting the marshmallow over a campfire until the inside of the marshmallow becomes soft. The toasted marshmallow is then removed from the skewer and placed between a pair of graham crackers, one of which has a piece of chocolate on it. It is preferably that the toasted marshmallow melts the chocolate. Accordingly, the assembled s'more comprising of a combination of melted marshmallow and chocolate carefully positioned between fragile graham crackers can be messy when consumed.

The popularity of s'mores have lead to various inventions to assist users in making s'mores. For example, U.S. Pat. No. 6,877,232 to Harmon et al. discloses a marshmallow toasting utensil that includes a handle and a wire assembly. More particularly, the wire assembly includes a pair of wires protruding outwardly from a handle. A user preferably urges the pair or wires together when a marshmallow is connected thereto. When the inside of the marshmallow melts, the pair of wires returns to their original position, thereby providing an indication to the user that the marshmallow is substantially melted.

Other inventions have been introduced to assist users in making s'mores. For example, U.S. Pat. No. 6,800,312 to Biggs discloses a marshmallow system that includes a marshmallow having a cavity formed therein to receive a piece of chocolate. Accordingly, when the marshmallow is toasted, the chocolate within the marshmallow will also be substantially melted. U.S. Pat. No. 6,296,884 to Okerlund discloses a pre-packaged s'more kit that contains a plurality of marshmallows, crackers, flavored wafers and a roasting utensil all positioned within an elongate container. Although the above inventions may decrease the time it takes to make a s'more, there still exists a need to provide a system to assemble a food that is not messy when eaten by the user.

### SUMMARY OF THE INVENTION

In view of the foregoing background, it is therefore an object of the present invention to provide a food product system and methods for assembling a food product that is not messy when eaten by the user. It is also an object of the present invention to provide a food product system and method that are easy to use. It is further an object of the present invention to provide a food product system and method that are enjoyable for users to assemble.

These and other objects, features, and advantages in accordance with the present invention are provided by a food product system comprising an edible handheld container, a skewer, and an edible core product. More specifically, the skewer may be moveable between an engaged position with the container and a disengaged position with the container. Further, the core product may be detachably connected to the skewer and selectively carried by the container. The core product may be detached from the skewer and selectively carried by the container as the skewer is moved from the engaged position with the container to the disengaged position with the container.

In one embodiment of the food product system, the container may have an open top, sidewalls extending downwardly from the open top, and a bottom opposite the open top. The open top, sidewalls and bottom preferably define a substantially conical shape. In this embodiment of the food product system, the sidewalls of the container may include at least one perforated section adjacent the bottom of the container. Accordingly, a lower portion of the sidewalls of the container may be removed to define the bottom of the container as an open bottom.

In this embodiment of the food product system, the core product may be detached from the skewer and selectively carried by the container when the skewer having the core product detachably connected thereto is moved from the engaged position to the disengaged position. More particularly, the engaged position of the skewer may be defined as the skewer being inserted into the top of the container, and the disengaged position may be defined by the skewer being extended out through the bottom of the container.

In another embodiment of the food product system, the sidewalls of the container having a substantially conical shape may include a perforated section adjacent the open top. Accordingly, a portion of the sidewalls of the container may be removed to define an opening in the sidewalls of the container. Similarly, in this embodiment of the food product system the core product may be detached from the skewer and selectively carried by the container when the skewer having the core product detachably connected thereto is moved from the engaged position to the disengaged position. More particularly, the engaged position may be defined by the skewer being inserted into the top of the container, and the disengaged position may be defined by the skewer being extended out through the opening in the sidewalls of the container.

In yet another embodiment of the food product system according to the present invention, the container may have a top, sidewalls extending downwardly from the top, and a bottom opposite the top so that the container has a substantially flat shape. In this embodiment, the container may have a perforated section positioned on a medial portion of the top and bottom. Accordingly, a portion of the top and bottom of the container may be removed to define a passageway through the top and bottom of the container. In this embodiment of the food product system, the core product may be detached from the skewer and selectively carried by the container when the skewer having the core product detachably connected thereto is moved from the engaged position with the container to the disengaged position with the container. More particularly, the engaged position may be defined by the skewer being inserted into the passageway, and the disengaged position may be defined by the skewer being extended outwardly through the passageway of the container.

In still another embodiment of the food product system according to the present invention, the container having the substantially flat shape may have a perforated section positioned along a side portion of the top and bottom. Accordingly, a portion of the top, bottom, and sidewall of the container may be removed to define an opening in the container. In this embodiment of the food product system, the core product may be detached from the skewer and selectively carried by the container when the skewer having the core product detachably connected thereto is moved from the engaged position to the disengaged position. More particularly, the engaged position may be defined by the skewer being inserted into the opening, and the disengaged position may be defined by the skewer being extended outwardly through the opening of the container

In a further embodiment of the food product system according to the present invention, the container may have an open top, sidewalls extending downwardly from the open top, and a bottom opposite the open top. The open top, sidewalls and bottom of the container may define a shape substantially similar to a cup.

In this embodiment of the food product system, the bottom of the container may include a perforated section. Accordingly, the perforated section may be removed to define the bottom of the container as an open bottom. In this embodiment, the core product may be detached from the skewer and selectively carried by the container when the skewer having the core product detachably connected thereto is moved from the engaged position with the container to the disengaged position with the container. More specifically, the engaged position may be defined as the skewer being inserted into the top of the container, and the disengaged position may be defined by the skewer being extended out through the bottom of the container.

In another embodiment of the food product system the sidewalls of the container having a shape substantially similar to a cup may include a perforated section in the sidewalls of the container. Accordingly, a portion of the sidewalls of the container may be removed to define an opening in the sidewalls of the container. Similarly, in this embodiment of the food product system the core product may be detached from the skewer and selectively carried by the container when the skewer having the core product detachably connected thereto is moved from the engaged position to the disengaged position. More particularly, the engaged position may be defined by the skewer being inserted into the top of the container, and the disengaged position may be defined by the skewer being extended out through the opening in the sidewalls of the container.

The container may be graham cracker material, cookie material, or flour based material, and the core product may be a marshmallow, fruit or bread, for example. Therefore, the food product system according to the present invention advantageously allows a user several different options when assembling the food product.

The skewer may be a wooden skewer or a bamboo skewer. The use of a wooden or bamboo skewer advantageously decreases heat conductivity through the skewer to decrease a burn risk to a user when heating the core product.

The food product system may also include a layer of confectionery material carried by the container. More specifically, the layer of confectionery material may be positioned on an interior portion of the container, an exterior portion of the container, or both.

A method aspect of the invention is for using a food product system to assemble a food product. The method may include detachably connecting the core product to the skewer and inserting the skewer having the core product connected thereto into the container. The method may also include removing the skewer from the container so that the core product is carried by the container when the skewer is removed therefrom.

Another method aspect of the invention is for assembling a food product. The method may include detachably connecting a core product to an elongate skewer and inserting the skewer into a container. The method may also include moving the skewer having the at least one core product detachably connected thereto between an engaged position with the container and a disengaged position with the container so that as the skewer is removed from the engaged position to the disengaged position, the core product is detached from the skewer and carried by the container to define an edible food product.

### BRIEF DESCRIPTION OF THE DRAWINGS

FIG. 1 is a perspective view of one embodiment of a food product system according to the present invention.

FIG. 2 is a perspective view of the food product system illustrated in FIG. 1 and showing a plurality of core products being detachably connected to a skewer.

FIG. 2A is a detailed view of a portion of a container of the food product system illustrated in FIG. 1.

FIG. 3 is an environmental view of an edible handheld container of the food product system illustrated in FIG. 1 showing a user removing a lower portion of the sidewalls of the container.

FIG. 4 is an environmental view of the core product of the food product system illustrated in FIG. 1 being warmed.

FIG. 5 is a perspective view of the food product system illustrated in FIG. 1 being assembled into a food product.

FIG. 6 is an environmental view of another embodiment of the food product system illustrating alternate core products.

FIG. 7 is an exploded perspective view of a layer of confectionery material being carried by the container according to the present invention.

FIG. 8 is a perspective view of another embodiment of a container of the food product system according to the present invention.

FIG. 9 is a perspective view of a perforated section being removed from the container illustrated in FIG. 8.

FIG. 10 is a perspective view of the food product system being assembled into a food product using the container illustrated in FIG. 8.

FIG. 11 is a perspective view of yet another embodiment of a container of the food product system according to the present invention.

FIG. 12 is a perspective view of a perforated section being removed from the container illustrated in FIG. 11.

FIG. 13 is a perspective view of the food product system being assembled into a food product using the container illustrated in FIG. 12.

FIG. 14 is a perspective view of still another embodiment of a container of the food product system according to the present invention.

FIG. 15 is a perspective view of a perforated section being removed from the container illustrated in FIG. 14.

FIG. 16 is a perspective view of the food product system being assembled into a food product using the container illustrated in FIG. 14.

FIG. 17 is a perspective view of still another embodiment of a container of the food product system according to the present invention.

FIG. 18 is a perspective view of a perforated section being removed from the container illustrated in FIG. 17.

FIG. 19 is a perspective view of the food product system being assembled into a food product using the container illustrated in FIG. 17.

FIG. 20 is a perspective view of still another embodiment of a container of the food product system according to the present invention.

FIG. 21 is a perspective view of a perforated section being removed from the container illustrated in FIG. 20.

FIG. 22 is a perspective view of the food product system being assembled into a food product using the container illustrated in FIG. 20.

FIG. 23 is a perspective view of a kit containing the elements of the food product system according to the present invention.

FIGS. 24 and 25 are flow charts illustrating method aspects of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notations are used to denote like elements in alternate embodiments.

Referring now initially to FIGS. 1-5, the food product system 10 according to the present invention is now described in greater detail. The food product system 10 illustratively includes an edible handheld container 12, a skewer 14 and core products 16. The food product system 10 according to the present invention may advantageously be used to assemble a food product 11. To assemble the food product 11, the skewer 14 may be moved between an engaged position with the container 12 and a disengaged position with the container, and the core product 16 is preferably detachably connected to the skewer and selectively carried by the container. Therefore, the food product 11 may be assembled by a user so that the core products 16 are carried by the container 12. More specifically, the core products 16 may be detached from the skewer 14 and selectively carried by the container 12 as the skewer is moved from the engaged position with the container to the disengaged position with the container.

Accordingly, the food product system 10 of the present invention may advantageously be used to assemble a food product 11 that is not messy when eaten by the user. The food product system 10 of the present invention may also advantageously allow the user to enjoy assembly of the food product 11.

In the embodiment of the food product system 10 illustrated in FIGS. 1-6, the edible handheld container 12 preferably has an open top 18, sidewalls 20, and a bottom 22. The bottom 22 is preferably positioned opposite the top 18, and the sidewalls 20 extend downwardly from the open top to the bottom. The open top 18, sidewalls 20, and bottom 22 preferably define a container 12 having a substantially conical shape. Those skilled in the art will appreciate, however, that the container 12 may have any other shape as will be discussed in greater detail below.

Although the food product system 10 is illustrated in FIGS. 1-6 as including one skewer 14, those skilled in the art will appreciate that any number of skewers may be included in: the food product system. The skewer 14 is preferably an elongate skewer and made of a material that does not conduct a substantial amount of heat. Preferable materials for the skewer 14 may include wood, bamboo or any other type of material that does not conduct excessive heat. Therefore, the skewer 14 may advantageously be used to heat core products 16, as will be described in greater detail below. Those skilled in the art will also appreciate that the skewer 14 may be made of any other material, such as: aluminium or another metal, and still accomplish the goals, features and advantages of the present invention.

Although the food product system 10 is illustrated in FIGS. 1-6 as including a plurality of core products 16, those skilled in the art will appreciate that any number of core products may be used to accomplish the features, benefits and advantages of the present invention. The core product 16 is preferably an edible core product that may be detachably connected to the skewer 14 and selectively carried by the container 12. More specifically, the core product 16 may be inserted into the container 12 using the skewer 14.

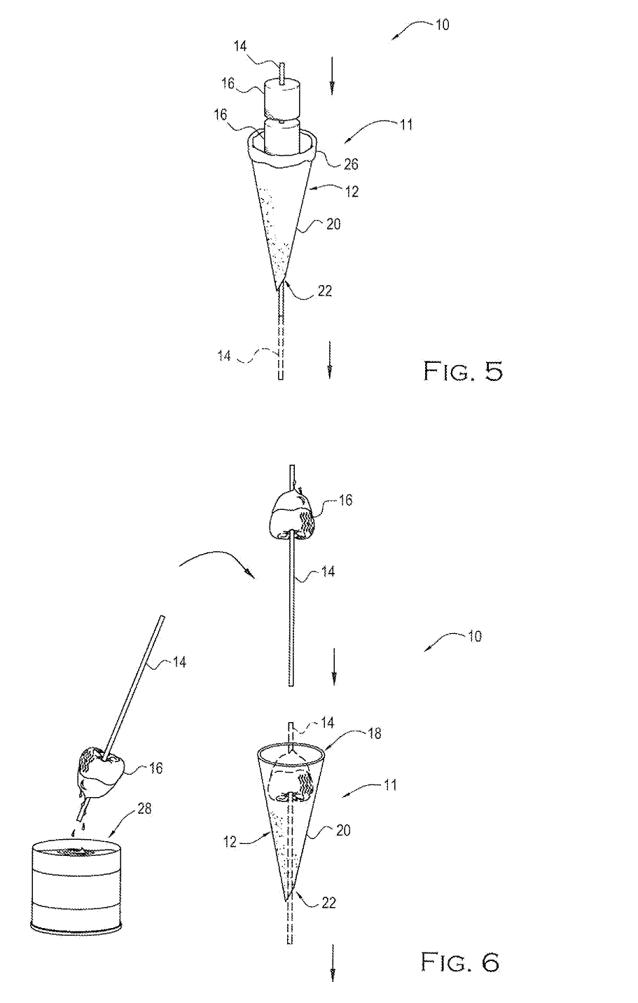

To position the core product 16 within the container 12, the skewer 14 carrying the core product may be moved from an engaged position with the container 12 to a disengaged position with the container. The skewer 14 is in the engaged position when it is being inserted into the top of the container 12. For example, as illustrated in FIG. 5, the skewer 14 is in the engaged position as it is inserted through the top of the container 12. The skewer 14 is thereafter moved to the disengaged position to detach the core product 16 therefrom, thereby leaving the core product to be carried by the container 12. More particularly, the disengaged position is preferably defined by the skewer 14 being extended outwardly through the bottom of the container 12. When the skewer 14 is moved from the engaged position with the container 12 to the disengaged position with the container, the core product 16 is left to be carried by the container, as the skewer is removed from within the container.

To be more specific, when the core product 16 is detachably connected to the skewer 14, and the skewer is inserted into the open top 18 of the container 12 and extended downwardly therethrough, the core product engages an interior portion of the sidewalls 20 of the container. The friction between the core product 16 and the interior sidewalls 20 of the container 12 is greater than the friction between the skewer 14 and the core product and, therefore, the skewer may be removed from container via the bottom 22 thereof, leaving the core product to be carried by the container.

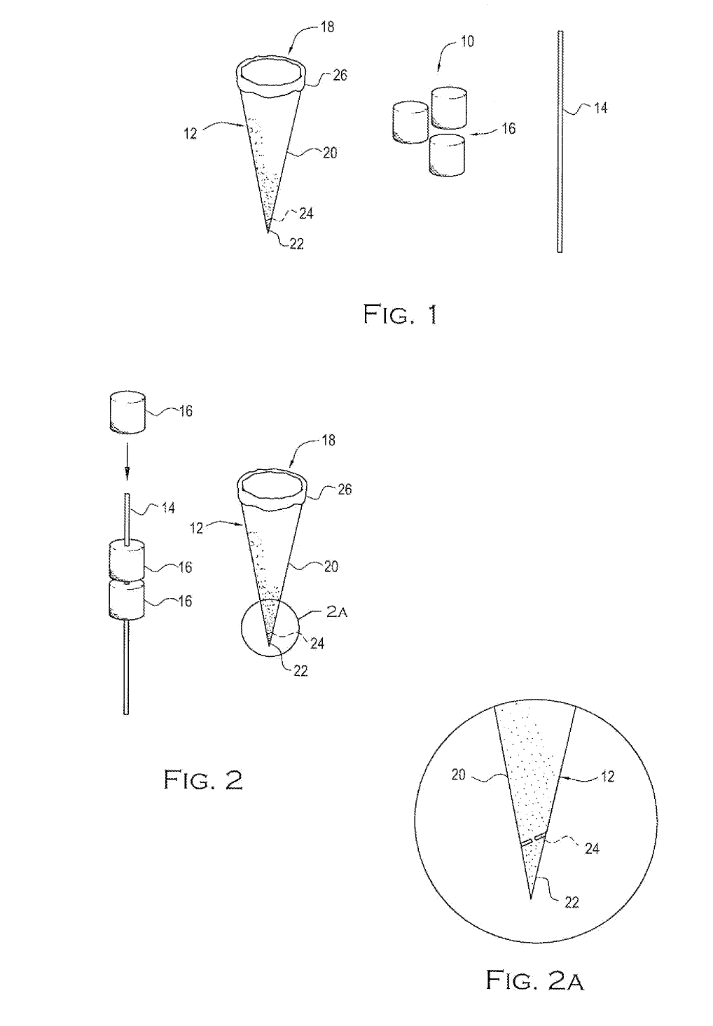

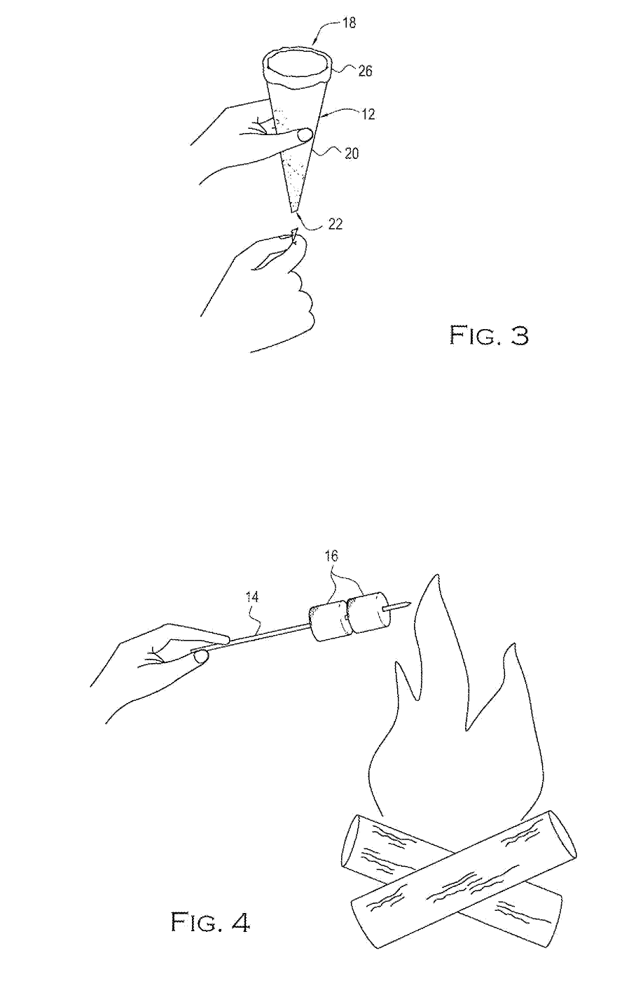

Referring now more specifically to FIGS. 2 and 2A, additional features of this embodiment of the food product system 10 according to the present invention are now described in greater detail. The sidewalls 20 of the container 12 may illustratively include a perforated section 24 adjacent the bottom 22 of the container. Accordingly, a lower portion of the sidewalls 20 of the container 12 may be removable. More specifically, and as perhaps best illustrated in FIG. 3, a user may remove the lower portion of the sidewalls 20 adjacent the bottom 22 of the container to define the bottom of the container as an open bottom.

The perforated section 24 of the container 12 may be positioned at a slant, as illustrated, for example, in FIGS. 2 and 2A. Accordingly, when the lower portion of the sidewalls 20 of the container 12 is removed, the bottom preferably has an oval shaped opening. Those skilled in the art will appreciate, however, that the perforated section 24 may have any other configuration. For example, the perforated section may be configured horizontally across the sidewalls 20 of the container 12, i.e., parallel to the open top 18. In such a configuration, the open bottom 22 would have a circular opening. In a configuration where the perforated section 24 is horizontal across the sidewalls 20 of the container 12, the opening of the bottom 22 would be somewhat smaller than in the configuration illustrated in FIGS. 2, 2A and 3, i.e. the configuration where the perforated section is slanted.

If the user chooses to remove the lower portion of the sidewalls 20 of the container 12, then the open bottom 22 may be blocked by the core product 16 when the core product is carried by the container. More specifically, and as illustrated in FIG. 5, when the core product 16 is inserted into the container 12, and the skewer 14 is removed through the open bottom of the container, the core product may block the open bottom. Therefore, the food product system 10 of the present invention advantageously allows the user to enjoy an assembled food product 11 that is not messy. In other words, blocking the open bottom 22 of the container 12 using the core product 16 advantageously prevents any leaking through the bottom of the container.

Those skilled in the art will appreciate that the container 12 may be provided with or without the perforated section 24. In other words, the container may be made to have the open bottom 22, thereby eliminating the need for the perforated section 24. As will be discussed in greater detail below, however, the inclusion of the perforated section 24, i.e., providing a container 12 with the ability to remove the lower portion of the sidewalls 20 if desired by the user, advantageously provides the user with different options to use the container. The open top 18, sidewalls 20 and bottom 22 of the container 12 are preferably integrally formed as a monolithic unit.

The container 12 may be made of any number of materials, but is preferably made of graham cracker material, cookie material, or any flour based material, as understood by those skilled in the art. The core product may, for example, be a marshmallow, a fruit, or a bread. Those skilled in the art will appreciate, however, that any other type of core product may be used to achieve the objects, features and advantages of the present invention.

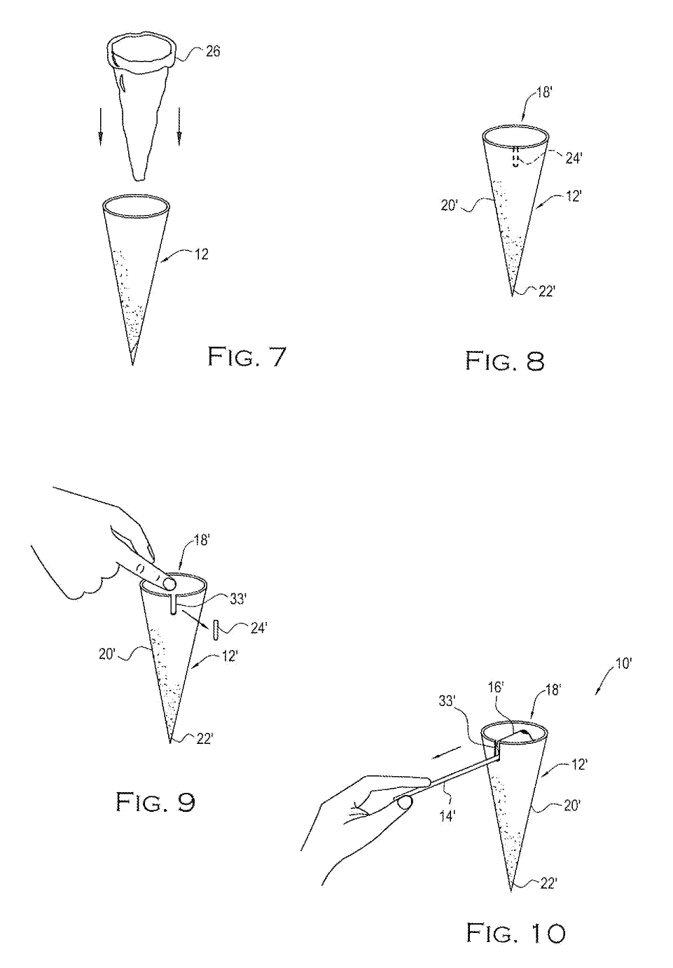

As perhaps best illustrated in FIG. 7, a layer of confectionery material 26 may be carried by the container 12. More specifically, the layer of confectionery material 26 may be positioned adjacent the interior sidewalls 20 of the container 12, an exterior portion of the sidewalls, or both the interior and exterior portions of the sidewalls. The layer of confectionary material 26 may, for example, be chocolate, powdered sugar, or any other suitable type of material.

In one embodiment, the food product system 10 may be used to assemble a food product that is similar to a s'more. As is known in the art, a s'more comprises graham cracker, chocolate, and marshmallow. These ingredients are generally assembled to form an edible food product. When the food product system 10 of the present invention is used to make a food product that has the ingredients of a s'more, the container 12 is preferably made of graham cracker material, and the confectionery material 26 that illustratively coats the interior portion of the sidewalls 20 and portion of the exterior sidewalls of the container is a chocolate material. The core products 16 may be marshmallows. As perhaps best illustrated in FIG. 3, the user may remove the lower portion of the sidewalls 20 of the container 12 and, as perhaps best illustrated in FIG. 4, the user may connect a plurality of marshmallow core products 16 to a skewer 14, and toast, or warm, the marshmallow core products over a fire.

Those skilled in the art will appreciate that marshmallows may be toasted or warmed in any number of ways, but that the preferred method of toasting a marshmallow is to use an open fire. After the marshmallow core products 16 are toasted or warmed, the marshmallow core products may be inserted into the graham cracker container 12 having the chocolate confectionary material 26 positioned thereon, as illustrated, for example, in FIG. 5, so that the marshmallow remains within the container and blocks the open bottom 22 when the skewer 14 is removed from the open bottom of the container.

As illustrated, for example, in FIG. 6, the food product system 10 may also be used to assemble several other types of food products. For example, the food product system may be used in a fondue application. In other words, the core product 16 may, for example, be a fruit, such as the strawberry illustrated in FIG. 6. The fruit may be detachably connected to the skewer 14, dipped into a sauce 28, and inserted into the container 12 so that the fruit is carried by the container when the skewer is removed through the bottom of the container. In such an embodiment, the container 12 may, for example, be a cracker material, a bread material, or any other type of suitable material.

The food product system 10 is not only limited to dessert applications. Those skilled in the art will appreciate that the food product system 10 of the present invention may advantageously be used to assemble any other type of food product 11. For example, the food product system 10 may be used in a “cheese and cracker” application, wherein the container 12 is made of a cracker material, and the skewer 14 is used to insert cheese or meat core products 16 into the container. Accordingly, the food product system 10 of the present invention may advantageously be used to assemble several different types of food products, all of which advantageously allow a user to enjoy an assembled food in a less messy fashion.

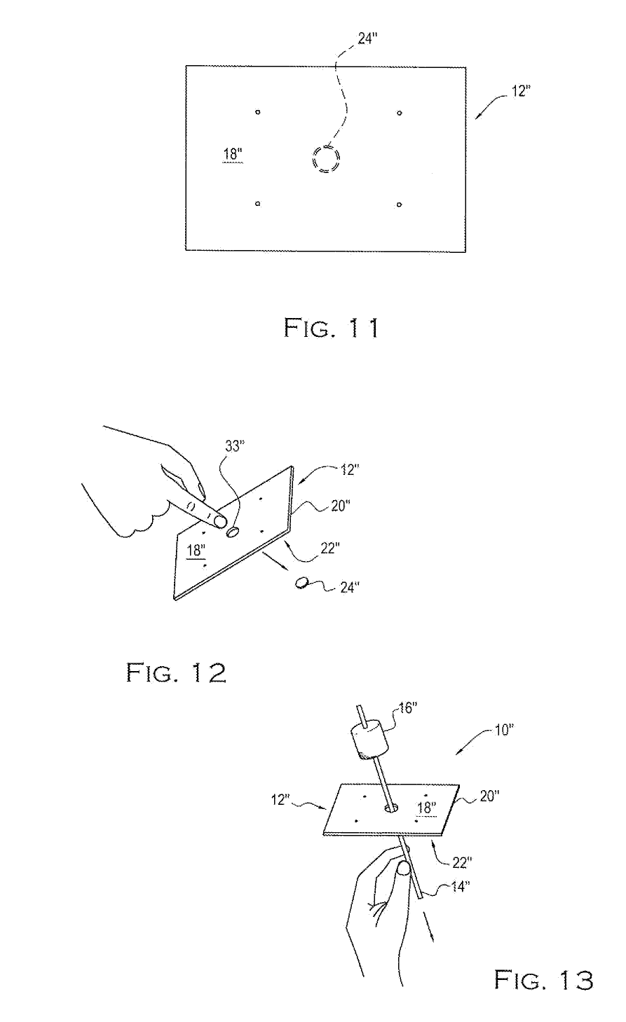

Referring now additionally to FIGS. 8-10, another embodiment of the container 12′ of the food product system 10′ according to the present invention is now described in greater detail. In this embodiment of the food product system 10′, the sidewalls 20′ of the container 12′ comprise a perforated section 24′ adjacent the open top 18′ so that a portion of the sidewalls of the container may be removed to define an opening 33′ in the sidewalls of the container.

In this embodiment of the food product system 10′, the core product 16′ is detached from the skewer 14′ and selectively carried by the container 12′ when the skewer having the core product detachably connected thereto is moved from the engaged position to the disengaged position. More specifically, the engaged position is defined by the skewer 14′ being inserted into the top 18′ of the container 12′ and engaging the opening 33′. The disengaged position is defined by the skewer 14′ being extended out through the opening 33′ in the sidewalls 20′ of the container 12′. The other aspects of this embodiment of the food product system 10′ are similar to those of the first embodiment of the food product system 10, are labelled with prime notation, and require no further discussion here.

Referring now additionally to FIGS. 11-13, another embodiment of the food product system 10″ according to the present invention is now described in greater detail. In this embodiment of the food product system 10″, the container 12″ has a top 18″, sidewalls 20″ extending downwardly from the top, and a bottom 22″ opposite the top. Accordingly, the container 12″ illustratively has a substantially flat shape. The substantially flat container 12″ illustratively includes a perforated section 24″ positioned adjacent a medial portion of the top 18″ and bottom 22″ of the container. Accordingly, a portion of the top 18″, sidewalls 20″ and the bottom 22″ of the container 12″ is removable to define a passageway 33″ through a medial portion of the container. The passageway 33″ is illustrated as being circular, but those skilled in the art will appreciate that the passageway may have any other shape.

The core product 16″ may be detached from the skewer 14″ and selectively carried by the container 12″ when the skewer having the core product detachably connected thereto is moved from the engaged position with the container 12″ to the disengaged position with the container. The engaged position is defined by the skewer 14″ having the core product 16′″detachably connected thereto being inserted into the passageway 33″. The disengaged position is defined as the skewer 14″ being extended outwardly through the passageway 33″ of the container 12″ so that the core product 16″ remains on the top 18″ of the container 12″. The other elements of this embodiment of the food product system 10″ are similar to those of the first embodiment of the food product system 10, are labelled with double prime notation, and require no further discussion herein.

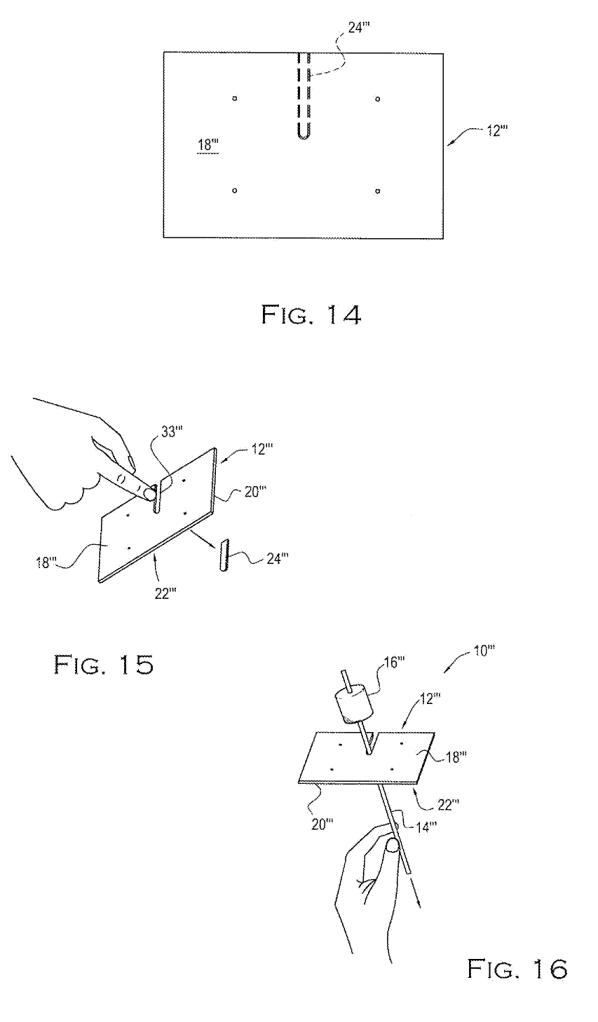

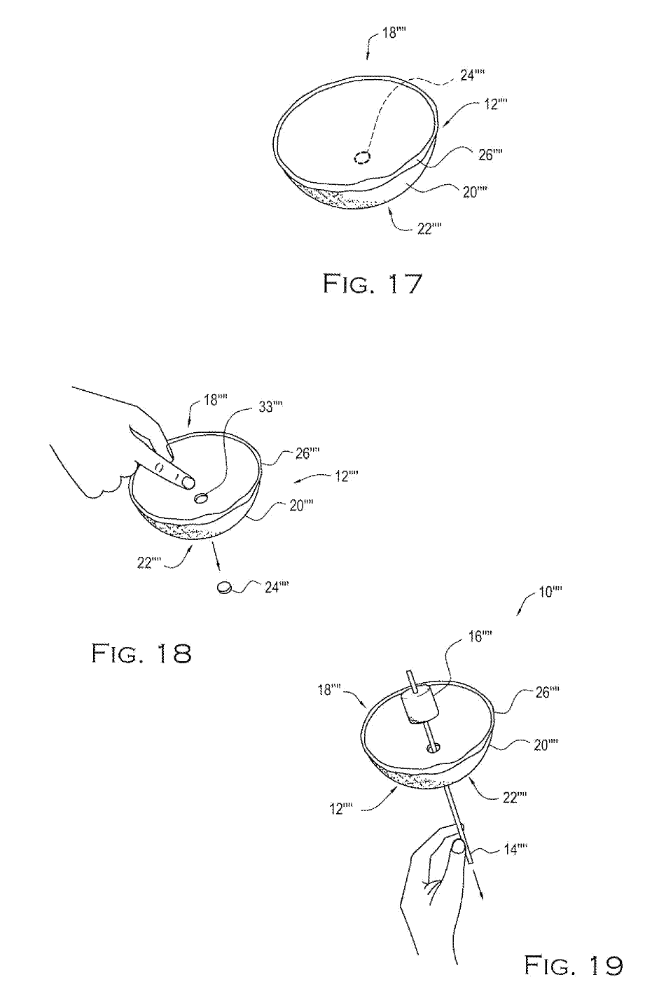

Referring now additionally to FIGS. 14-16, still another embodiment of the food product system 10′″ is now described in greater detail. The container 12′″ of this embodiment of the food product system 10′″ is substantially similar to the container 12″ of the second embodiment of the food product system 10″. In other words, the container 12′″ of this embodiment of the food product system 10′″ has a substantially flat shape. The container 12′″ also comprises a perforated section 24′″. This perforated section 24′″, however, is positioned along a side portion of the top 18′″ and bottom 22′″ of the container 12′″, and is removable to define an opening 33′″ in the container. The opening 33′″ is preferably a U-shaped opening, but those skilled in the art will appreciate that the opening may have any other shape.

Similar to the previous embodiment of the food product system 10″, in this embodiment of the food product system 10′″, the core product 16′″may be detached from the skewer 14′″ and carried by the container 12′″ when the skewer carrying the core product is moved from the engaged position with the container to the disengaged position with the container. The engaged position with the container 12′″ is defined by the skewer 14′″ matingly engaging the opening in the container. The disengaged position is defined by the skewer 14′″ being extended outwardly through the opening 33′″ of the container 12′″ so that the core product 16′″ is detached from the skewer and carried by the top 18′″ of the container. The other aspects of this embodiment of the food product system 10′″ are similar to those of the previous embodiment of the food product system 10′″, are labelled with triple prime notation, and require no further discussion herein.

Referring now additionally to FIGS. 17-19, another embodiment of the food product system 10″″ according to the present invention is now described in greater detail. In this embodiment of the food product system 10″″, the container 12″″ has an open top 18″″, sidewalls 20″″ extending downwardly therefrom, and a bottom 22″″ opposite the open top. The open top 18″″, sidewalls 20″″ and bottom 22″″ define a container 12″″ having a shape substantially similar to a cup. The bottom 22″″ of the cup-shaped container 12″″ illustratively includes a perforated section 24″″ that is removable to define a passageway 33″″ in the bottom of the container so that the container has an open bottom.

The core product 16″″ may be detached from the skewer 14″″ and selectively carried by the container 12″″ when the skewer having the core product detachably connected thereto is moved from the engaged position with the container 12″″ to the disengaged position with the container. The engaged position with the container is preferably defined as the skewer 14″″ having the core product 16″″ connected thereto is inserted into the open top 18″″ of the container 12″″ and through the passageway 33″″. The disengaged position with the container 12″″ is preferably defined by the skewer 14″″ being extended outwardly through the open bottom 33″″ of the container 12″″ so that the core product 166″″ remains carried by the container after the skewer has been removed therefrom. The other aspects of this embodiment of the food product system 10″″ are similar to those of the first embodiment of the food product system 10, are labelled with multiple prime notation, and require no further discussion herein.

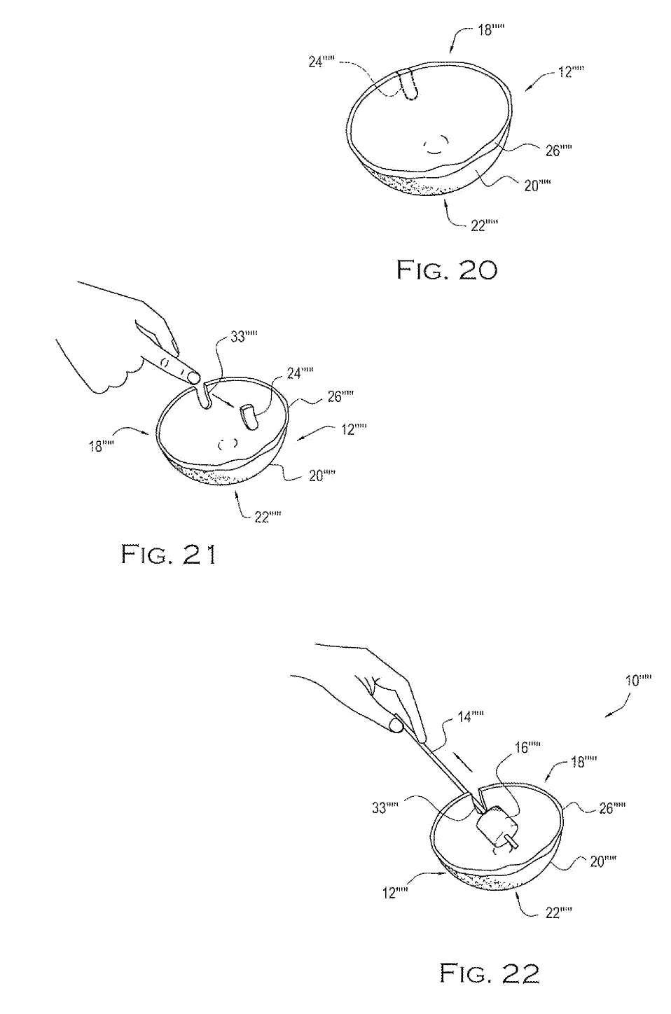

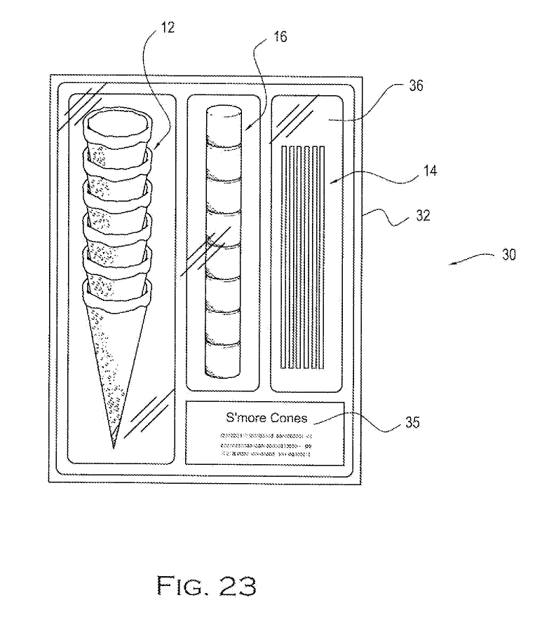

Referring now additionally to FIGS. 20-22, yet another embodiment of the food product system 10′″″ is now described in greater detail. This embodiment of the food product system 10′″″ is similar to the previous embodiment of the food product system 10″″ in that the container 12′″″ has a shape substantially similar to a cup. The perforated section 24′″″, however, is positioned on the sidewalls 20′″″ of the container 12′″″ and preferably adjacent to the open top 18′″″ thereof. The perforated section 24′″″ is illustratively removable to define an opening 33′″″ in the sidewall 20′″″ of the container 12′″″.

The core product 16′″″ may be detached from the skewer 14′″″ and selectively carried by the container 12′″″ when the skewer having the core product detachably connected thereto is moved from the engaged position with the container to the disengaged position with the container. The engaged position is preferably defined by the skewer 14′″″ having the core product 16′″″ detachably connected thereto matingly engaging the opening 33′″″ in the sidewalls 20′″″ of the container 12′″″. The disengaged position is preferably defined by the skewer 14′″″ being extended outwardly through the opening 33′″″ in the sidewalls 20′″″ of the container 12′″″ so that the core product 16′″″ is detached from the skewer and carried by the container. The other aspects of this embodiment of the food product system 10′″″ are similar to those of the previous embodiment of the food product system 10″″, are labelled with multiple prime notation, and require no further discussion herein.

Referring now additionally to FIG. 23, another aspect of the present invention is now described in greater detail. More specifically, the present invention may include a food product system kit 30. The kit 30 preferably includes a container 32 for holding the components of the food product system 10. The container 32 may, for example, be a segmented container. In other words, the container 32 may include multiple segmented compartments for carrying the various components of the food product system 10.

By way of example, and with reference to the food product system kit 30 illustrated in FIG. 23, the plurality of compartments may include a first segmented compartment for carrying the edible containers 12, a second segmented compartment for carrying the core products 16, and a third segmented compartment for carrying the skewers 14. Those skilled in the art will appreciate that the segmented container 32 may include any number of segmented compartments.

The kit 30 may also include indicia 35 printed on the container 32, or directions having indicia printed thereon and carried by the container. The indicia 35 may, for example, include directions for use, nutritional information, or any other suitable indicia as understood by those skilled in the art. The kit 30 may also include a cover 36 so that the segmented container may be resealable. More specifically, the cover 36 may matingly engage the container. Accordingly, the kit 30 advantageously allows the components of the food product system 10 to be used over extended periods of time without the components within the kit becoming stale.

The kit 30 advantageously allows a user to customize the food product 11 being assembled. For example, some users may chose to use more core products 16 when assembling the food product 11. In such a case, the user may find that there are some additional containers 12 left over. The containers 12 may advantageously be used outside of the food product system 10. For example, the container 12 may be suitable for use as an ice cream cone. Therefore, the removable bottom 22 of the container 12 becomes more advantageous as it allows a user to choose to use the container in the food product system 10 application, or for any other application, i.e., an ice cream cone.

Although using the container 12 as an ice cream cone is the only alternate application that has been discussed herein, those skilled in the art will appreciate that the alternate applications of the container 12 are not limited to use in ice cream. For example, the container 12 may alternately be used to carry any type of core product 16 where it is desirous for the core product not to leak through the bottom 22 of the container. Of course, when using the container in the preferred embodiment of a s'more, those skilled in the art appreciate that the core product marshmallow 16 is used to block the open bottom 22, thereby preventing any leaking through the bottom of the container 12 and advantageously allowing a user to enjoy the s'more in a less messy fashion.

A method aspect of the present invention is for using a food product system 10 to assemble a food product 11. The method may include detachably connecting the core product 16 to the skewer 14. The method may include detaching the core product 16 from the skewer 14 by moving the skewer from an engaged position with the container 12 to a disengaged position with the container. More particularly, the method may include inserting the skewer 14 having the core product 16 connected thereto into the container 12 through the open top 18 thereof. The method may further include removing the skewer 14 through the bottom 22 of the container 12 so that the core product 16 is carried by the container when the skewer is removed therefrom. The method may still further include warming the core product 16 when connected to the skewer 14 before inserting the skewer into the container 12.

As perhaps best illustrated in FIG. 4, the core product 16 may, for example, be a marshmallow. Further, after the marshmallow is connected to the skewer 14 it may, for example, be warmed or toasted before being inserted into the container 12. The method may also include removing perforated section 24 of the container 12 so that the container may have an opening or passageway. The various embodiments of the container 12-12′″″have been discussed above, specifically outlining various shapes of the containers, and positioning of the perforated sections 24-24′″″. Accordingly, the skewer 14 may be extended downwardly through the opening or passageway formed in the container so that the skewer may be removed from within the container and the core products 16 may be carried by the container after removal of the skewer. Therefore, the method may also include blocking the opening or passageway in the container 12 with the core product 16 when carried by the container.

Another method aspect of the present invention is for assembling a food product 11. The method may include detachably connecting a core product 16 to an elongate skewer 14. The method may also include inserting the skewer 14 into the container 12, and removing the skewer from the container so that the core product 16 is detached from the skewer and carried by the container when the skewer is removed therefrom.

Yet another method aspect of the present invention is for using a kit to assemble a food product 11. More specifically, the method may include opening the segmented container 32 and removing the components of the food product system 10 from therein. The method may also include reading the directions contained within the kit 30 and assembling the food product 11 using the components of the food product system 10 carried by the kit.

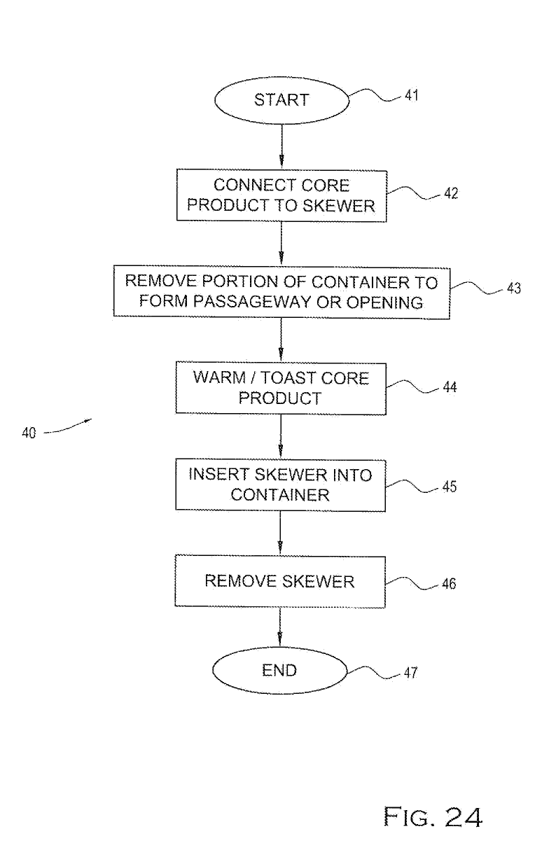

Referring now additionally to the flow chart 40 in FIG. 24, additional method aspects of the food product system 10 are now described in greater detail. More specifically, from the start (block 41) a core product 16 is connected to a skewer 14 at block 42. At block 43, a portion of the container 12 is removed to form a passageway or opening in the container. At block 44, the core product 16 is warmed or toasted.

At block 45, the skewer 14 is inserted into the container 12. At block 46, the skewer 14 is removed from the container 12. More particularly, the skewer 14 is pulled through the opening or passageway formed in the container 12 so that the core product 16 remains carried by the container after the skewer has been removed therefrom. The method is ended at block 47.

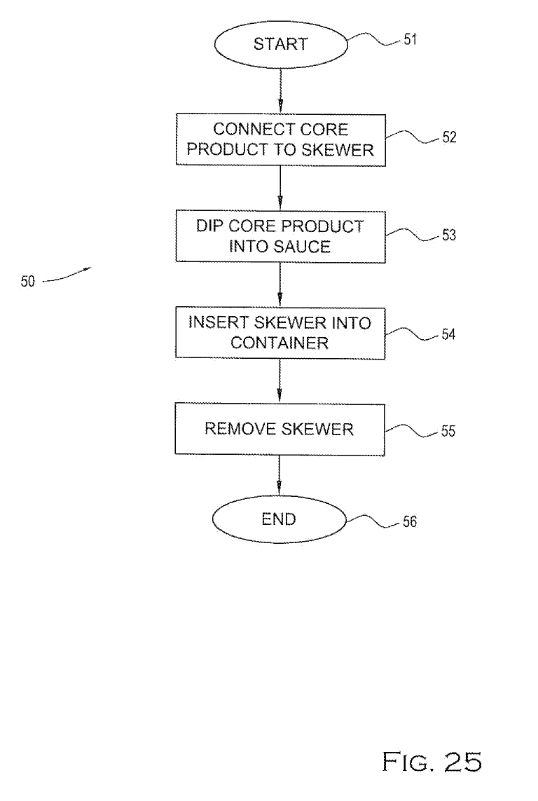

Referring now additionally to the flow chart 50 of FIG. 25, another method aspect of the present invention is now described in greater detail. From the start (block 51), the core product 16 is connected to the skewer 14 at block 52. At block 53, the core product 16 is dipped into a sauce. More particularly, the core product may, for example, be a fruit, and the sauce 28 may, for example, be a fondue-type sauce. At block 54, the skewer 14 having the core product 16 connected thereto is inserted into the container 12. At block 55, the skewer 14 is removed from the container 12. When the skewer 14 is removed from the container 12, the core product 16 remains within the container and is carried thereby. The method is ended at block 56.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A food product system comprising:
an edible handheld container; and
at least one edible core product adapted to be detachably connected to at least one skewer and selectively carried by said container;
wherein said at least one core product is detached from the at least one skewer and selectively carried by said container as the at least one skewer is moved from an engaged position with said container to a disengaged position with said container.

2. A food product system according to claim 1 wherein said container has an open top, sidewalls extending downwardly from the open top, and a bottom opposite the open top, the open top, sidewalls and bottom defining a substantially conical shape.

3. A food product system according to claim 2 wherein the sidewalls of said container comprise at least one perforated section adjacent the bottom of said container so that a lower portion of the sidewalls of said container is removable to define the bottom of said container as an open bottom.

4. A food product system according to claim 3 wherein said at least one core product is detached from the at least one skewer and selectively carried by said container when the at least one skewer having said at least one core product detachably connected thereto is moved from the engaged position, defined as the at least one skewer being inserted into the top of said container, to the disengaged position, defined by the at least one skewer being extended out the bottom of said container.

5. A food product system according to claim 2 wherein the sidewalls of said container comprise at least one perforated section adjacent the open top so that a portion of the sidewalls of said container is removable to define an opening in the sidewalls of said container.

6. A food product system according to claim 5 wherein said at least one core product is detached from the at least one skewer and selectively carried by said container when the at least one skewer having said at least one core product detachably connected thereto is moved from the engaged position, defined by the at least one skewer matingly engaging the opening in the sidewalls of said container, to the disengaged position, defined by the at least one skewer being extended out through the opening in the sidewalls of said container.

7. A food product system according to claim 1 wherein said container has a tops sidewalls extending downwardly from the top, and a bottom opposite the top, said container having a substantially flat shape.

8. A food product system according to claim 7 wherein said container comprise at least one perforated section positioned on a medial portion of the top and bottom so that a portion of the top and bottom of said container is removable to define a passageway through the top and bottom of said container.

9. A food product system according to claim 8 wherein said at least one core product is detached from the at least one skewer and selectively carried by said container when the at least one skewer having said at least one core product detachably connected thereto is moved from the engaged position with said container, defined by the at least one skewer being inserted into the passageway, to the disengaged position with said container, being defined as the at least one skewer being extended outwardly through the passageway of said container.

10. A food product system according to claim 7 wherein said container comprise at least one perforated section positioned along a side portion of the top and bottom so that a portion of the top, bottom, and sidewall of said container is removable to define an opening in said container.

11. A food product system according to claim 10 wherein said at least one core product is detached from the at least one skewer and selectively carried by said container when the at least one skewer having said at least one core product detachably connected thereto is moved from the engaged position with said container, defined by the at least one skewer matingly engaging the opening, to the disengaged position with said container, being defined as the at least one skewer being extended outwardly through the opening of said container.

12. A food product system according to claim 1 wherein said container has an open top, sidewalls extending downwardly from the open top, and a bottom opposite the open top, the open top, sidewalls and bottom defining a container having a shape substantially similar to a cup.

13. A food product system according to claim 12 wherein the bottom of said container comprise at least one perforated section that is removable to define the bottom of said container as an open bottom.

14. A food product system according to claim 13 wherein said at least one core product is detached from the at least one skewer and selectively carried by said container when the at least one skewer having said at least one core product detachably connected thereto is moved from the engaged position with said container, defined as the at least one skewer being inserted into the top of said container, to the disengaged position with said container, defined by the at least one skewer being extended out through the open bottom of said container.

15. A food product system according to claim 12 wherein the sidewalls of said container comprise at least one perforated section so that a proportion of said sidewalls of said container is removable to define an opening in the sidewalls of said container.

16. A food product system according to claim 15 wherein said at least one core product is detached from the at least one skewer and selectively carried by said container when the at least one skewer having said at least one core product detachably connected thereto is moved from the engaged position, defined by the at least one skewer matingly engaging the opening in the sidewalls of said container, to the disengaged position, defined by the at least one skewer being extended out through the opening in the sidewalls of said container.

17. A food product system according to claim 1 wherein said container comprises at least one of graham cracker material, cookie material, and flour based material.

18. A food product system according to claim 1 wherein said at least one core product comprises at least one of a marshmallow, a fruit and a bread.

19. A food product system according to claim 1 wherein the at least one skewer is at least one of a wooden skewer and a bamboo skewer.

20. A food product system according to claim 1 further comprising a layer of confectionery material carried by said container and positioned adjacent at least one of an interior portion of said container and an exterior portion of said container.

21. A method of using a food product system to assemble a food product, the food product system comprising an edible handheld container, at least one core product and a skewer, the method comprising:
detachably connecting the at least one core product to the skewer;
inserting the skewer having the at least one core product connected thereto into the container; and
removing the skewer from the container so that the at least one core product is carried by the container when the skewer is removed therefrom.

22. A method according to claim 21 further comprising warming the at least one core product when connected to the skewer before inserting the skewer into the container.

23. A method according to claim 21 wherein the container has an open top, sidewalls extending downwardly from the open top, and a bottom opposite the open top, the open top, sidewalls and bottom defining a substantially conical shape.

24. A method according to claim 23 wherein the sidewalls of the container comprise at least one perforated section adjacent the bottom of the container; and further comprising removing a lower portion of the sidewalls of the container to define the bottom of the container as an open bottom.

25. A method according to claim 24 further comprising detaching the at least one core product from the at least one skewer and wherein the at least one core product is selectively carried by the container when the at least one skewer having the at least one core product detachably connected thereto is moved from an engaged position defined as the at least one skewer being inserted into the top of the container, to a disengaged position, defined by the at least one skewer being extended out the bottom of the container.

26. A method according to claim 25 further comprising blocking the open bottom with the at least one core product when carried by the container.

27. A method according to claim 23 wherein the sidewalls of the container comprise at least one perforated section adjacent the open top; and further comprising removing a portion of the sidewalls of the container to define an opening in the sidewalls of the container.

28. A method according to claim 27 further comprising detaching the at least one core product from the at least one skewer and wherein the at least one core product is selectively carried by the container when the at least one skewer having the at least one core product detachably connected thereto is moved from the engaged position, defined by the at least one skewer being inserted into the top of the container to the disengaged position, defined by the at least one skewer being extended out through the opening in the sidewalls of the container.

29. A method according to claim 21 wherein the container has a top, sidewalls extending downwardly from the top, and a bottom opposite the top, the container having a substantially flat shape.

30. A method according to claim 29 wherein the container comprise at least one perforated section positioned on a medial portion of the top and bottom so that a portion of the top and bottom of the container is removable to define a passageway through the top and bottom of the container.

31. A method according to claim 30 further comprising detaching the at least one core product from the at least one skewer and wherein the at least one core product is selectively carried by the container when the at least one skewer having the at least one core product detachably connected thereto is moved from the engaged position with the container to the disengaged position with the container as it is passed through the passageway through the top and bottom of the container.

32. A method according to claim 31 further comprising blocking the passageway with the at least one core product when carried by the container.

33. A method according to claim 29 wherein the container comprise at least one perforated section positioned along a side portion of the top and bottom; and further comprising removing a portion of the top, bottom, and sidewall of the container to define an opening in the container.

34. A method according to claim 33 further comprising detaching the at least one core product from the at least one skewer and wherein the at least one core product is selectively carried by the container when the at least one skewer having the at least one core product detachably connected thereto is moved from the engaged position with the container to the disengaged position with the container as it is inserted into the opening and extended outwardly through the opening in the container.

35. A method according to claim 21 wherein the container has an open top, sidewalls extending downwardly from the open top, and a bottom opposite the open top, the open top, sidewalls and bottom defining shape substantially similar to a cup.

36. A method according to claim 35 wherein the bottom of the container comprises at least one perforated section; and further comprising removing a portion of the bottom to define the bottom of the container as an open bottom.

37. A method according to claim 36 further comprising detaching the at least one core product from the at least one skewer and wherein the at least one core product is selectively carried by the container when the at least one skewer having the at least one core product detachably connected thereto is moved from the engaged position with the container to the disengaged position with the container as it is inserted into the top of the container and extended out the open bottom so that the at least one core product is detached from the at least one skewer when extended through the bottom of the container.

38. A method according to claim 37 further comprising blocking the open bottom with the at least one core product when carried by the container.

39. A method according to claim 35 wherein the sidewalls of the container comprise at least one perforated section; and further comprising removing a proportion of the sidewalls of the container to define an opening in the sidewalls of the container.

40. A method according to claim 39 further comprising detaching the at least one core product from the at least one skewer and wherein the at least one core product is selectively carried by the container when the at least one skewer having the at least one core product detachably connected thereto is moved from the engaged position with the container to the disengaged position with the container as it is inserted into the opening and extended outwardly through the opening in the container.

41. A method according to claim 21 wherein the container comprises at least one of graham cracker material, cookie material, and flour based material; wherein the at least one core product comprises at least one of a marshmallow, a fruit and a bread; and wherein the at least one skewer is at least one of a wooden skewer and a bamboo skewer.

42. A method according to claim 21 further comprising a layer of confectionery material carried by the container and positioned adjacent at least one of an interior portion of the container and an exterior portion of the container; and wherein the layer of confectionery material is at least one of chocolate and sugar.

43. A method of assembling a food product comprising:
detachably connecting at least one core product to an elongate skewer; and
moving the skewer having the at least one core product detachably connected thereto between an engaged position with an edible handheld container and a disengaged position with the container so that as the skewer is removed from the engaged position to the disengaged position, the at least one core product is detached from the skewer and carried by the container to define an edible food product.

44. A method according to claim 43 further comprising warming the at least one core product when connected to the skewer before inserting the skewer into the container.

45. A method according to claim 43 wherein the container comprises a removable portion, and further comprising removing the removable portion to define an opening in the container.

46. A method according to claim 45 further comprising blocking the opening in the container with the at least one core product when carried by the container.

47. A method according to claim 43 wherein the container comprises at least one of graham cracker material, cookie material, and flour based material; wherein the at least one core product comprises at least one of a marshmallow, a fruit and a bread; and wherein the skewer is at least one of a wooden skewer and a bamboo skewer.

48. A method according to claim 43 wherein the container includes a layer of confectionery material positioned adjacent at least one of an interior portion of the container and an exterior portion of the container; and wherein the confectionery material is at least one of chocolate and sugar.
